(19) United States
(12) Patent Application Publication
(10) Pub. No.: US 2008/0210256 A1
(43) Pub. Date: Sep. 4, 2008

(54) Method of and Device for Cleaning a Metal Sheet

(75) Inventors: Matthias Kretschmer, Koln (DE); Hans-Georg Hartung, Pulheim (DE)

Correspondence Address: ABELMAN, FRAYNE & SCHWAB, 666 THIRD AVENUE, 10TH FLOOR, NEW YORK, NY, 10017, US

(73) Assignee: Halssen & Lyon GMBH, Hamburg (DE)

(21) Appl. No.: 11/883,034

(22) PCT Filed: Feb. 22, 2006
(86) PCT No.: PCT/EP2006/001602

§ 371 Date: Jul. 23, 2007

(30) Foreign Application Priority Data
Feb. 26, 2005 (DE) 10 2005 008 939.9

(51) Int. Cl. B08B 3/12; B08B 13/00

(52) U.S. Cl. 134/1; 134/61

(57) ABSTRACT

The invention relates to a method of a cleaning a metal strip (1). In order to improve the cleaning of the strip, according to the invention, it is provided that the metal strip (1) is first subjected to a first high-pressure cleaning (4) with at least one liquid jet in a first region (2) of a cleaning device (3), and in that the metal strip (1) thereafter is subjected to an ultrasonic cleaning (6) in a second region off the cleaning device (3), at which the metal strip (1) is displaced through a container filled with liquid. The invention further relates to a device for cleaning a metal strip.

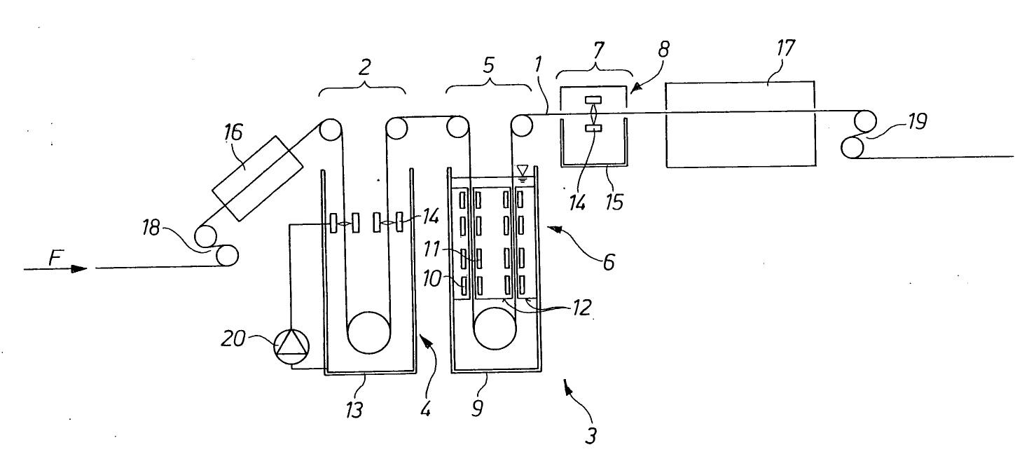

The invention relates to a method of cleaning a metal strip. The invention further relates to a device for cleaning a metal strip.

The essential requirements to refined light-gauge sheet metal products are their good treatability in the following manufacturing processes and a long-lasting preservation of the end product. These characteristics are basically determined by functional layers which are put onto the surface of the metal strip. The bonding between the functional layer, e.g., a zinc coating and the surface of a steel sheet is based first of all on the bonding forces in the boundary surface, contaminants on the surface such as, e.g., fine metal particles, oil and emulsion residues reduce bonding. Then, the functional layer cannot fulfill its task. It is applied non-uniformly and, e.g., easily becomes loose again under a mechanical load.

In order, in particular, to remove damaging deposits from the surface of a to-be-refined metal sheet before entry of the sheet in a refining process, the strip is usually brought in an intensive contact with alkali cleaning means in a strip cleaning installation. The strip cleaning in a hot dip galvanizing line primarily consists of a combination of different alkali cleaning processes and a concluding watery rinsing.

For manufacturing of a galvanized metal strip in a hot dip galvanizing installation or in an annealing line, often, a cold-rolled metal strip is used that should be thoroughly cleaned before refining. Cold-rolled strips come out from rolling process covered with a rolling emulsion and rolling sediments. Impurities of about 500 mg/m² per strip side consisting of rolling emulsion, iron abrasions, and the like dirt are typical. The metal strip, which is contaminated in this manner, must be freed from these residues of the cold-rolling process before a further surface refinement.

State of the art discloses diverse possibilities for managing this. Mostly, a multi-stage strip cleaning is carried out. With it, a combination of alkali spray cleaning with the use of brushes for removal of the surface dirt, electrolytic cleaning for cleaning deep pores, and concluding, multi-stage watery rinsing with the use of brushes. As cleaning means, watery solution on the basis of alkalis, surface active agents, and phosphates are used.

In the first portion of a such strip cleaning section, the strip is brought to the necessary process temperature and is freed from the surface impurities by a hot alkaline cleaning solution.

In the spray degreasing section, the strip is intensively sprayed with a hot cleaning medium in order to heat it to a desired temperature and to loose coarse sticking impurities. During the spray degreasing, the strip can be displaced horizontally or vertically.

During the brush degreasing, the impurities on the strip surface are removed with a plurality of rotatable brushes. The brush device is typically equipped with two or four brush roller units. The brushes are offset one after another with counter rollers or directly above each other for cleaning the strip bottom and top sides. The mechanical contact of bristles with the surface of the metal strip leads to not insignificant wear of the brushes. Dependent on the operational mode and the required quality, the brush rollers should be replaced about every three months, which is associated with not insignificant costs.

The electrolytic degreasing involves a direct dissolving of impurities on the surface of the strip which lie deeper in the topography. This can take place at vertical or horizontal displacement of the strip. The dissolving is effected by application of an outer voltage to a pair of electrodes above and below the metal strip. For an electrical insulation of the container in which the degreasing is effected, it is formed as a rubberized steel container. During the bipolar process, an electrolytic reaction takes place between the strip surface and the surrounding electrodes, which leads to formation of oxygen and hydrogen bubbles. The formation of the hydrogen gas requires an expensive safeguard technology to prevent the danger of explosion of oxy-hydrogen gases. Therefore, constantly, a large amount of air should be fed to the process container for its forced ventilation. Therefore, the electrolytic degreasing is associated with different drawbacks.

Thereafter, i.e., after the electrolytic treatment, the metal strip surface is treated with a brush during a rinsing process so that the remaining surface deposits are removed. This brush device is also mostly equipped with two or four brush roller units, where the brushes are offset one after another with counter-rollers or are directly arranged one above the other. Mechanical wear is here also a drawback, so that the brushes should be replaced about every three months.

Finally, the surface of the metal strip is rinsed in a multiple cascade rinsing installation with a hot demineralized water in order to wash off completely the cleaning solution there. From two to four spray rinsing units, which are arranged one after another and are separated by squeezing roller units, can be used. The cascade-like feeding of the rinsing liquid minimizes the water consumption. The combination of blow-off of strip edges and strip drying after finishing of the strip cleaning guarantees a complete drying of the strip surface over the entire strip width and prevents carry-over of liquids.

Under favorable conditions, with foregoing measures in the strip cleaning installation, a degree of cleaning of about 90% is achieved, i.e., the initial dirtiness of a metal strip is reduced to about 10%.

The state of the alt discloses other solution for cleaning a metal strip, wherein mostly they relate to partial aspects of cleaning.

EP 0 235 595 A2 describes a strip cleaning installation in which instead of conventional brushes, in conclusion of the electrolyze, a high-pressure cleaning is provided. There are provided an electrolytic predegreasing, mechanical cleaning with rotating brushes or a high-pressure cleaning, a further electrolytic degreasing, a further mechanical cleaning with rotatable brushes or high-pressure cleaning, and a concluding rinsing. The described process requires, because of the electrolysis, numerous safety devices to prevent explosions of the oxy-hydrogen gas.

EP 0 601 991 B1 discloses a device for cleaning metal strips which operate exclusively with high-pressure liquid jets with pressure up to maximum 60 bar.

RU 2 191 641 CI discloses a cleaning device in which a to-be-cleaned strip is displaced in a container in which an ultrasonic crystal is arranged in the vicinity of the metal strip surface. The cavitation, which is induced by ultrasonic waves, blows off the impurities from the strip surface. Anyway, the degree of cleaning, which is achieved with the described cleaning device, is not adequate under all circumstances.

Ultra-sounds also used for cleaning a metal strip in a solution according to U.S. Pat. No. 4,788,992. The strip is here displaced between two ultrasonic oscillators formed as plates and which oscillate with different frequencies. The device generates an ultrasonic near-field about the to-be-cleaned field, so that the impurities are dissolved.

JP 09 171 986 A discloses a spray nozzle with which an ultrasonic-cleaning liquid is sprayed onto a to-be-cleaned strip. Immediately in front of and behind the nozzle, high-pressure cleaning nozzles, as units with a spray nozzle for the ultrasonic-cleaning liquid, are positioned, respectively, in order to improve cleaning effect.

EP 0 578 824 B1 displaces a to-be-cleaned strip from a liquid container filled with cleaning fluid to subject it to ultrasonic cleaning in a separate chamber.

U.S. Pat. No. 5,975,098 likewise suggests an ultrasonic cleaning of a strip, however, here, the point of application of the ultrasound is directly impinged with the cleaning means from a high-pressure cleaning nozzle.

WO 02/18065 A2 also discloses use of the ultrasonic cleaning, whereas U.S. Pat. No. 6,488,993 discloses a solution in which the cleaning device for the strip is not specified in detail.

All of the known solutions relate more or less to partial aspects of the cleaning method and/or cleaning device. The requirements to high-output strip cleaning installations with regard to cost-efficiency and cleaning quality are generally higher than those which can be met by the existing methods and devices.

Further, often, the required criteria with regard to ecology are not met because the use of chemical cleaning means burdens the environment, and meeting of the corresponding legal requirements is cost-intensive.

The known cleaning methods are deficient with regard to investment, energy, and operational costs, as well as with regard to the efficiency of the cleaning process.

Accordingly, an object of the invention is to so improve the method and the device that the existing drawbacks are eliminated. Altogether, an advantageous strip cleaning method and an associated device should be provided with which an economical, efficient, and ecological cleaning of a metal strip before its refining becomes possible.

This object is achieved according to the invention in that the metal strip is first subjected to a first high-pressure cleaning with at least one liquid jet in a first region of a cleaning device, and in that the metal strip thereafter is subjected to an ultrasonic cleaning in a second region of the cleaning device, at which the metal strip is displaced through a container filled with liquid.

The invention combines the high-pressure cleaning of the strip and the subsequent ultrasonic cleaning. It has been established that the sequence of these method steps provides an improved cleaning result. The first region is advantageously spaced from the second region.

The metal strip can, in conclusion of the ultrasonic cleaning, be subjected in a third region of the cleaning device to a second high-pressure cleaning with at least one fluid jet. The second region is likewise spaced from the third region.

Optimal results are achieved when the first and, if necessary, the second high-pressure cleaning process is effected with at least one liquid jet covering the width of a to-be-cleaned metal strip and applied with a pressure between 50 bar and 200 bar, preferably, between 100 bar and 120 bar to the surface of the metal strip.

The metal strip can be displaced vertically at least during one of the high-pressure cleanings and/or during ultrasonic cleaning.

Advantageously, during the first high-pressure cleaning and, if necessary, during the second high-pressure cleaning, the used liquid is heated to a temperature of at least 60° C., preferably, to a temperature of more than 80° C.

In order to bond dirt particles which were removed from the strip and to, thereby, prevent that they reach again the strip surface upon circulation of the cleaning means, according to the further development, it is suggested that at the ultrasonic cleaning, and, if necessary, at the second high-pressure cleaning, the used liquid contains surface-active agents for bonding the removable impurities.

Further, the liquid, which is used at the first high-pressure cleaning, at the ultrasonic cleaning, and, if necessary, at the second high-pressure cleaning can contain surface-active agents and/or phosphate.

Further, an alkaline liquid can be used.

As is known in the state of the art, before the first high-pressure cleaning, a spray degreasing of the metal strip, in particular in an immersion or spray container, is effected.

The spray degreasing of the metal strip can be carried out with a medium, in particular with a cleaning medium, that has a temperature of at least 60° C., preferably, above 80° C. After the second high-pressure cleaning in conclusion, rinsing, in particular cascade rinsing with water, of the metal strip can be carried out.

The device for cleaning a metal strip is characterized by a first region in which a high-pressure cleaning device is located, and a second region which is arranged downstream, in the feeding direction of the metal strip, and in which an ultrasonic cleaning device is located, wherein the ultrasonic cleaning device has a container which is filled with liquid and in which ultrasound-emitting means is arranged.

The ultrasound-emitting means can be arranged in a respective housing, in particular in a stainless steel housing in the interior of the container on both sides of the metal strip. The high-pressure cleaning device and the ultrasonic cleaning device have, advantageously, separate containers through which the metal strip is displaced. In a third region, which is arranged downstream, in the feeding direction of the metal strip, of the ultrasonic cleaning device, a second high-pressure cleaning device can be located. The high-pressure cleaning devices can have at least one high-pressure nozzle beam extending over an entire width of the strip. Also, the high-pressure cleaning device in the third region can have a separate container through which the metal strip is displaced.

In the feeding direction of the metal strip, in front of the first high-pressure cleaning device, advantageously means for spray-degreasing of the metal strip is arranged. Further, advantageously, in the feeding direction of the metal strip, behind the second high-pressure cleaning device, means for rinsing of the metal strip is arranged.

Because foam formation cannot be avoided during the high-pressure cleaning, the high-pressure cleaning devices include a Pitot-tube pump for generating the required high pressure of the liquid.

Such a pump is formed of two main components, namely, of a rotatable pump housing and a stationary arranged Pitot-tube (Pitot-static tube-pressure principle). The fed liquid enters through a rotary seal and a rotary channel at the inlet side and into the rotating rotor housing, and is brought to a high speed. The centrifugal force urges the liquid toward the rotor periphery, which causes suction at the inlet and forms a ring of liquid in the rotor. When liquid enters the stationary Pitot-tube, the kinetic energy is converted into a potential energy, therefore, the pressure is increased. In this way, the pressure up to 200 bar at a rotary speed of about 8,000 revolutions per minute is achieved. The fluid, which is held under the constant pressure in the Pitot-tube, then flows to the outlet, i.e., toward the high-pressure side of the pump.

The combination of inventive features provides a cleaning method and a cleaning device having a high cleaning efficiency and, at the same time provides for a cost-effective operation. Namely, no brush systems with mechanical contact are used for cleaning the strip, so that the wear in the installation is minimized.

The drawing shows an example of an embodiment of the invention. The single FIGURE shows schematically a cleaning device for cleaning a metal strip before its hot dip galvanizing.

The FIGURE shows a cleaning device 3 for cleaning a metal strip 1 that is fed in a feeding direction F (from left) to the device 3 and again leaves it (toward right). The strip 1 continuously runs through the cleaning device 3 with a predetermined feeding speed. In the embodiment example, the cleaning device 3 is provided for a high output hot dip galvanizing or annealing line for cold-rolled strips 1.

The cleaning device 3 has essentially three regions following each other in the feeding direction F, namely, a first region 2, a second region 5, and a third region 7. In the first region 2, a first high-pressure cleaning device 4 is located, in the second region 5, an ultrasonic cleaning device 6 is located, and in the third region 7, a second high-pressure cleaning device 8 is located.

In front of the first region 2, means 16 for spray-degreasing is located, as it is known for a long time in the state-of-the-art. At the end of the third region 7, there is provided rinsing means 17, as likewise well known.

In the means 16 for spray-degreasing, the strip 1 is heated by immersion in a hot cleaning medium (in case of an immersion tank) or by spraying with a hot cleaning medium (in case of a spray tank) and is freed from easily sticking surface contaminants.

With two S-roller tracks 18 and 19, the metal strip 1 is tensioned.

Essential is that the entire cleaning device 3 is brushless, i.e., there is no need to use rotary cleaning brushes, as is known and conventional in the state-of-the-art. The complete cleaning of the strip 1 is effected only with means shown in the drawings. A mechanical contact between the brush bristles and the strip 1 leads to a correspondingly high wear which, in turn, leads to high operational costs. This is prevented according to the invention.

A further essential aspect of the invention consists in that likewise electrolytic degreasing means is eliminated, which is widely used in the state-of-the-art. The electrolytic degreasing process requires an expensive construction of the process container. In addition, the formation of oxygen and hydrogen in the process presents a safety risk. The design of the device is substantially simplified by elimination of the electro-chemical reaction according to the invention. The gas formation-free process according to the invention does not require any particular measures for vacuuming the container and is uncritical from the safety point of view.

The first high-pressure device 4 has a separate container 13 in which high-pressure nozzle beams 14 are provided on opposite sides of the strip 1. In the embodiment example, there are provided altogether four beams 14 for branches of the strip 1 extending vertically downwardly and vertically upwardly.

The high-pressure cleaning combines cleaning of surfaces by a surface-active process (surface-active agents in the cleaning medium) with the mechanical removal using the kinetic energy of liquid jets. The hot cleaning fluid is applied with high speed to the strip surface. Loose surface depositions are flushed away. Stable layers are loosened by the kinetic energy of the applied liquid and are likewise flushed away. The liquid components of the strip cleaner partially contribute to the cleaning process. The essential function of the surface-active agents is binding of the removable impurities with the liquid. The removable layer is bound within the liquid phase and does not contact the strip surface any more. In this way, secondary greasing or contamination is prevented. Without the surface-active component, the greasing components of the removable impurities would have been floating over the liquid due to their small thickness and non-polar structure and, eventually, would have deposited again on the strip surface upon a new contact therewith.

The high pressure of the used liquid, which is necessary for the high-pressure cleaning, is produced by a Pitot-tube pump 20. The cleaning medium enters through a suction union into the pump chamber. Contrary to conventional kinetic pumps, a very high rotational speed is produced in the rotating pump chamber. The stationary Pitot tube extends in the rotating liquid body. In this tube, the kinetic rotational energy of the medium is converted into a potential pressure energy. The high rotational speed of the medium increases the pressure of liquid at the discharge side, which can reach, without any problem, 100 bar and even exceed it. The cost-effective use of the high-pressure cleaning requires recirculation of the cleaning medium and, thereby, a multiple passing of the multi-phase liquid (consisting of a liquid phase of the cleaner and enclosed gas or foam bubbles) through the pump 20. With the use of alkali, surface-active agent containing cleaners, foam formation in medium cannot be completely avoided. In kinetic or piston pumps, even small gas components in medium, already lead to cavitation damages in the pump chamber and, therefore, to pump failure already after a short time. The proposed Pitot-tube pump is characterized by a relatively high insensitivity to air and foam (gas component smaller than 10% by volume) in the fed medium. As a result of the pressure distribution, the gas components accumulate centrally in the interior of the liquid body where they cannot contact the stationary Pitot tube with changed pressure conditions. In the pump chamber, a rapidly rotating liquid ring, with a gas pocket in its rotational center, is formed. The additional outside flushing of a rotary seal reduces wear by particles in the medium.

In the second region 5, the ultrasonic device 6 is located in a separate container 9. Here also, the strip 1 has downwardly and upwardly extending branches. On both sides of the strip 1, in both branches, a number of ultrasonic emission elements 10 and 11 is provided, which are arranged in a stainless steel housing 12 that is connected with the walls of the container 9.

The ultrasonic cleaning combines the cleaning of the surfaces by a surface-active process (surface-active agents in the strip cleaning medium) with the mechanical removal by kinetic energy of imploding gas bubbles. The ultrasonic vibrations lead to local pressure fluctuations in the media chamber. In the region, in which the pressure falls below the gas pressure of the released gas or of the vapor pressure of the liquid, tiny cavitation bubbles are formed. Because artificial conditions that lead to the formation of bubbles, exist only for a short period of time, the bubbles implode again very rapidly. The produced, thereby, pressure waves, which are induced in the liquid by implosion of the gas bubbles, in particular, on the strip surface, lead to blasting of impurities off the strip surface. Loose surface deposits are removed. Stable layers are loosened by the pressure waves and are likewise flushed away. The surface-active agents in the strip cleaner contribute to the cleaning process as in the above-described high-pressure cleaning.

A big advantage of cleaning with ultra-sound consists, in addition to the high quality and reproducibility, in mechanical and nevertheless contactless cleaning of materials. In accordance with cleaning requirements, aggressive chemicals and high temperatures can be dispensed with. With the watery ultrasonic cleaning, the supporting chemical additions (cleaning means) are fed in very small amount percent wise and are, in their selection with respect to the existing impurities, as significant as the selection of ultrasound power and the operational frequency. Dependent on the use and the application field, the ultrasonic cleaning permits to obtain high-quality and homogenous cleaning results which cannot be achieved by any other cleaning process.

The used ultrasonic vibration technology does not require any particular bath maintenance. The ultrasound emission means 10, 11, as explained, are encapsulated by the stainless steel housing 12. The housing material can be adapted to the bath medium. The container 9 is formed as an immersion tank in order to receive a satisfactory medium for transmission of sonic waves to the strip surface. In the immersion tank, only a huge flow velocity is to be set in order that the formed bubbles are not immediately flush away off the strip surface and/or to prevent propagation of the sonic waves.

In the third region 7, the second high-pressure cleaning device 8 is located which likewise has a separate container 15. In this container, as in the first high-pressure cleaning device 4, high-pressure nozzle beams are provided on opposite sides of the strip 1.

Different practical experiments confirmed the efficiency of the combined high-pressure—ultrasonic technology. Based on the conducted experiments, it was confirmed that a technically dirty steel strip can be cleaned with good results by high-pressure and ultrasonic cleaning. The high-pressure cleaning takes care of good rough cleaning. The kinetic energy of high-pressure water jets acts on the surface deposits. The top layer is removed. Impurities that lie deeper in the topography of the surface of the strip 1 are loosed by ultrasonic cleaning and are removed. The formation and implosion of separate gas bubbles, which are produced by ultrasonic vibrations, on the strip surface blast the bonded residual deposits off.

It is advantageous that the existing installations, if necessary, can be equipped with the inventive cleaning device 3. The brush degreasing and brush bristles are replaced by a pair of respective high-pressure nozzle beams. The electrolytic degreasing section is replaced by an ultrasonic cleaning section by substitution of an ultrasonic system for the electrode system.

The brush degreasing is replaced by a pair of high-pressure nozzles. The high-pressure nozzle pair is located immediately behind the spray degreasing. At this point, the steel strip has already been heated to the necessary temperature to provide for optimal effectiveness of the used cleaning medium and to minimize foam formation. The high-pressure water jets can provide, in combination with cleaning active substances in the medium, for removal of impurities lying on the strip surface. The removal is effected in contactless manner due to the high kinetic energy of the water jets and, therefore, practically wear-free over a very long period of time.

The substitution of the ultrasonic cleaning for electrolytic cleaning noticeably simplified the design of the strip cleaning device. The container for the ultrasonic cleaning has a simplified construction and is formed as a pure steel container without isolation rubber (as necessary with the electrolyse).

Contrary to the electrolytic cleaning, the ultrasonic cleaning does not release any electrolyse gases. The process container is connected with a simple suction installation.

The brush rinsing is replaced by a second pair of high-pressure nozzles (high-pressure nozzle beams 14) in the third region 7. The high-pressure nozzle pair is located at the beginning or immediately in front of the first stage of the adjoining cascade rinsing 17. At this point, there is located, on the surface of the steel strip 1, a film of impurities that were loosened during ultrasonic cleaning and that can be removed by the high-pressure cleaning in the third region 3 in combination with presence of cleaning active substances in the medium. The removal is effected in a contactless manner due to the high kinetic energy of the water jets and, thus, wear-free to a most possible extent.

The use of the high-pressure cleaning technology as replacement for the mechanical brush cleaning eliminates costs for replacement brushes which, as a wearable element, should be regularly replaced in the known cleaning devices. The ultrasonic cleaning, as a replacement for the electrolytic cleaning, consumes less energy for achieving the desired cleaning results. The compactness of the process technologies provides new possibilities for construction and building of space-saving high-output cleaning means in strip handling lines.

It has further been shown that based on the high effectiveness of the strip cleaning by the proposed cleaning method, a noticeable saving of cleaning chemicals can be achieved. The environment-polluting components (surface-active agents, phosphate, etc.) in the cleaning means can be reduced. The cleaning of the waste water can be effected with smaller costs and energy consumption.

The strip displacement in separate region of the cleaning device 3 can be alternatively effected horizontally or vertically.

Basically, it is possible, in addition to the proposed elements of the device which themselves can be replaceable, to use those known in the state-of-the-art, i.e., spray cleaning means, brush cleaning means, and electrolytic cleaning means.

### LIST OF REFERENCE NUMERALS

1 Metal strip
2 First region
3 Cleaning device
4 First high-pressure cleaning device
5 Second region
6 Ultrasonic cleaning device
7 Third region
8 Second high-pressure cleaning device
9 Container
10 Ultrasound-emission means
11 Ultrasound-emission means
12 Housing
13 Container
14 High-pressure nozzle beams
15 Container
16 Means for spray degreasing
17 Means for rinsing
18 S-roller table
19 S-roller table
20 Pitot-tube pump
F Feeding direction

1-22. (canceled)

23. A method of cleaning a metal strip (1),
characterized in that
the metal strip (1) is first subjected to a first high-pressure cleaning (4) with at least one liquid jet in a first region (2) of a cleaning device (3), and in that the metal strip (1) thereafter is subjected to an ultrasonic cleaning (6) in a second region of the cleaning device (3), at which the metal strip (1) is displaced through a container filled with liquid, and that the metal strip (1) is subjected, upon completion of the ultrasonic cleaning process (6), to a second high-pressure cleaning (8) with at least one liquid jet in a third region (7) of the cleaning device (3).

24. A method according to claim 23,
characterized in that
the first region (2) is spaced from the second region (5), and that
the third region (7) is spaced from the second region (5).

25. A method according to claim 23,
characterized in that
the first and, if necessary, the second high-pressure cleaning process (4, 8) is effected with at least one liquid jet covering the width of a to-be-cleaned metal strip (1) and applied with a pressure between 50 bar and 200 bar, preferably, between 100 bar and 120 bar to the surface of the metal strip (1).

26. A method according to claim 23,
characterized in that
the metal strip (1) is displaced vertically at least during one of the high-pressure cleanings (4, 8) and/or during ultrasonic cleaning (6).

27. A method according to claim 23,
characterized in that
during the first high-pressure cleaning (4) and, if necessary, during the second high-pressure cleaning (8) the used liquid is heated to a temperature of at least 60° C., preferably, to a temperature of more than 80° C.

28. A method according to claim 23,
characterized in that
at the first high-pressure cleaning (4), at the ultrasonic cleaning (6), and if necessary, at the second high-pressure cleaning (8), the used liquid contains surface-active agents for bonding removable impurities.

29. A method according to claim 23,
characterized in that
at the first high-pressure cleaning (4), at the ultrasonic cleaning (6), and, if necessary, at the second high-pressure cleaning (8), the used liquid contains surface-active agents and/or phosphate.

30. A method according to claim 23,
characterized in that
at the first high-pressure cleaning (4), at the ultrasonic cleaning (6), and, if necessary, at the second high-pressure cleaning (8), the used liquid is alcaline.

31. A method according to claim 23,
characterized in that
before the first high-pressure cleaning (4), a spray degreasing of the metal strip (1), in particular in an immersion or spray container, is effected.

32. A method according to claim 31,
characterized in that
the spray degreasing of the metal strip (1) is carried out with a medium, in particular with a cleaning medium, that has a temperature of at least 60° C., preferably, above 80° C.

33. A method according to claim 23,
characterized in that
after the second high-pressure cleaning (8), rinsing, in particular cascade rinsing with water, of the metal strip (1) is carried out.

34. A device (3) for cleaning a metal strip (1),
characterized by
a first region (2) in which a high-pressure cleaning device (4) is located, a second region (5) which is arranged downstream, in the feeding direction (F) of the metal strip (1) and in which an ultrasonic cleaning device (6) is located, wherein the ultrasonic cleaning device (6) has a container (9) which is filled with liquid and in which ultrasound-emission means (10, 11) is arranged, and a third region (7) which is arranged downstream, in the feeding direction (F) of the metal strip (1), of the ultrasonic cleaning device (6), and in which a second high-pressure cleaning device (8) is located.

35. A device according to claim 34,
characterized in that
the ultrasound-emitting means (10, 11) is arranged in a respective housing (12), in particular in a stainless steel housing, in the interior of the container (9) on both sides of the metal strip (1).

36. A device according to claim 34,
characterized in that
the high-pressure cleaning devices (4, 8) and the ultrasonic cleaning device (6) have separate containers (13, 9, 15) through which the metal strip (1) is displaced.

37. A device according to claim 34,
characterized in that
the high-pressure cleaning devices (4, 8) have at least one high-pressure nozzle beam (14) extending over an entire width of the strip (19).

38. A device according to claim 34,
characterized in that
in the feeding direction (F) of the metal strip (1), in front of the first high-pressure cleaning device (4), means for spray degreasing of the metal strip (1) is arranged.

39. A device according to claim 34,
characterized in that
in the feeding direction (F) of the metal strip (1), behind the second high-pressure cleaning device (4), means for rinsing of the metal strip (1) is arranged.

40. A device according to claim 34,
characterized in that
the high-pressure cleaning devices (4, 8) have a Pitot-tube pump (20) for producing high pressure of the liquid.
